(19) United States
(12) Patent Application Publication
(10) Pub. No.: US 2006/0028402 A1
(43) Pub. Date: Feb. 9, 2006

(54) Method for controlling an image display device

(76) Inventors: Dominique Gagnot, Charavines (FR); Gerard Rilly, St Etienne Crossey (FR); Ana LaCoste, St Martin le Vinoux (FR)

Correspondence Address: THOMSON LICENSING INC., PATENT OPERATIONS, PO BOX 5312, PRINCETON, NJ, 08543-5312, US

(21) Appl. No.: 11/173,285

(22) Filed: Jun. 30, 2005

(30) Foreign Application Priority Data
Jul. 1, 2004 (FR) 0451386

(51) Int. Cl. G09G 3/20

(52) U.S. Cl. 345/55

(57) ABSTRACT

The present invention relates to a method for controlling an image display device and an image display device implementing this method. The invention relates more specifically to a display device having a matrix of cells, a column driver circuit and a column amplifier with resonant circuitry to recover energy. The invention proposes to optimize the method for controlling the column amplifier to reduce to zero the energy losses during the switching actions of the switches of the column driver circuit. To this end, the invention proposes to position the start of the period of oscillation of the resonant circuit in a manner dependent on the capacitance of the columns of cells connected to the resonant circuit via the column driver circuit such that the switching actions of the switches of the column driver circuit always take place when the voltage delivered by the column amplifier is zero.

### FIELD OF THE INVENTION

The present invention relates to a method for controlling an image display device and an image display device implementing this method.

More specifically, the invention can be applied to display devices having a matrix of cells arranged in rows and columns, the cells of which may or may not be activated by a write voltage, a row driver circuit to sequentially select the rows of cells, a column driver circuit having a plurality of switches to apply via said switches a write signal to the columns of cells to be activated for the selected row and a resonant circuit to generate said write signal, said write signal having a first oscillation phase in which it swings from a write voltage to zero voltage, said resonant circuit having an inductance resonating with the capacitance of the columns of cells to be activated for the selected row during said first oscillation phase and at least one switch for triggering said oscillation.

### BACKGROUND OF THE INVENTION

The invention can in particular be applied to plasma display devices and will be described in the case of such devices.

During the phase for addressing cells of the matrix of cells of a plasma panel, the switches of the column driver circuit are controlled to apply either a write voltage or a zero voltage to the cells depending on the video data to be displayed. In practice, the write voltage, from now on denoted V_{w}, is in the order of 60 volts and the total capacitance C of the columns of cells to be controlled may reach 100 nF when all the columns of cells are selected.

Without a capacitive energy recovery device, the consumption losses during the switching actions of the switches of the column driver circuit can reach several tens of watts. In practice, these losses are equal to:
C_{col}·V_{col}²·F
where: C_{col} is the capacitance of the columns of cells selected by the column driver circuit;
V_{col} is the voltage present on the columns selected at the moment when the switches of the column driver circuit are about to change state; and
F is the switching frequency.

As well as this undesirable consumption, the switches of the column driver circuit must be overdimensioned to dissipate this energy.

Energy recovery devices commonly known as column amplifiers have therefore been developed to minimize these losses. The principle behind these devices is to cause the capacitance of the columns of cells to oscillate with an inductance to change the voltage applied to the columns from the write voltage V_{w} to 0 volts and vice versa. A typical column amplifier, referenced 10, is represented in FIG. 1. It is connected, via a column driver circuit D, to the columns of cells selected by the latter and which are represented in the figure by their capacitances. It includes two switches S₁ and S₂, an inductive element L, two voltage sources G₁ and G₂ and three diodes D₁, D₂ and D₃. Inductive element L is intended to form a resonant circuit with the capacitances of the columns of cells selected by the column driver circuit when switch S₁ is closed. Signal V_{col} delivered by the column amplifier has a shape as represented in FIG. 2. The write voltage V_{w} is equal to the sum of voltages V₁ and V₂ delivered by sources G₁ and G₂. The swing V_{w}→0 is triggered by opening switch S₂. The operation of this amplifier will be described in more detail later.

Currently, the switching action instants of the column driver circuit switches and the opening instant of switch S₂ are synchronized on a predetermined clock signal H. Switch S₂ is for example opened at each pulse start of signal H and the switches of the column driver circuit are actioned with a fixed delay T_{c} with respect to these pulses. This case is illustrated in FIG. 3 representing signal V_{col} delivered by the column amplifier for two different column capacitance values. From now on in the description, the term “column capacitance” refers to the capacitance of the columns selected by the column driver circuit and is denoted C_{col}. With reference to FIG. 3, a first curve, in solid line, represents signal V_{col} delivered by the column amplifier between two consecutive switching action instants t₀ and t₁ of the column driver circuit for a first column capacitance value C₁. A second curve, in dotted line, represents the same signal for a lower column capacitance value C₂. Switch S₂ is opened at an instant t′₀ placed between switching action instants t₀ and t₁. This instant corresponds to a rising edge of clock signal H. The swing V_{w}→0 therefore starts at instant t₀′ and is synchronous with the pulse start of clock signal H. Switching action instant t₁ is chosen to be equal to t′₀+T_{c}. Thus, the switches of column driver circuit D are always actioned with a delay T_{c} with respect to the start of the swing V_{w}→0. Since delay T_{c} is fixed, it is independent of the capacitance of the switched columns. The switching action of the switches of column driver circuit D therefore mostly occurs when voltage V_{col} is not zero, in which case the switching losses are equal to

$$\frac{1}{2} {C}_{col} \cdot {V}_{col}^{2} \cdot F .$$

This is the situation in FIG. 3 when the column capacitance is equal to C₂ (dotted line curve). In fact, the losses are zero only for one particular column capacitance value which is, in the example of FIG. 3, the value C₁ (solid line curve in FIG. 3). This particular value corresponds in general to the capacitance Cₜₒₜ representing the capacitance of all the columns of the panel. In this case, the length of delay T_{c} is therefore taken to be equal to the half-period of oscillation of the resonant circuit, i.e. T_{c}=π\sqrt{L·Cₜₒₜ}(=π\sqrt{L·C₁} in FIG. 3) where L denotes the inductance of inductive element L.

### SUMMARY OF THE INVENTION

According to the invention, the aim is to reduce to zero the switching action losses in the circuit regardless of the capacitance of the switched columns.

To this end, provision is made to control the start of the period of oscillation (V_{w}→0) according to the capacitance of the columns of cells being activated such that the switches of the column driver circuit are actioned at the end of said first oscillation phase.

Furthermore, the invention relates to a control method in an image display device including:
a matrix of cells arranged in rows and columns, which cells may or may not be activated by a write voltage,
a row driver circuit to sequentially select the rows of cells,
a column driver circuit, having a plurality of switches, to apply via said switches a write signal to the columns of cells to be activated for the selected row,
a resonant circuit to generate said write signal, said write signal having a first oscillation phase in which it swings from a write voltage to zero voltage, said resonant circuit having an inductive element resonating during said first oscillation phase with the capacitance of the columns of cells being activated for the selected row,
in which the start of the first oscillation phase is determined as a function of the capacitance of the columns of cells being activated and in which the switches of the column driver circuit are controlled to change state at the end of said first oscillation phase,
wherein the start of the first oscillation phase is determined from the duration of a prior oscillation phase, called the second oscillation phase, during which the write signal swings from zero voltage to the write voltage for the same number of cells being activated in the selected row.

The switches of the column driver circuit are thus actioned when the voltage supplied by the column amplifier is zero. The switching action losses (C_{col}·V_{col}²·F) are therefore zero.

According to a particular embodiment, the change of state of the switches of the column driver circuit is offset by a fixed delay with respect to the pulses of a clock signal and the change of state of the switch of the resonant circuit is offset by a variable delay with respect to the pulses of the clock signal. This variable delay is a function of the capacitance of the columns having cells being activated in the selected row.

This variable delay may be calculated by:
measuring the duration of the second oscillation phase, and
deriving the length of the variable delay which is equal to the time difference between the duration of the second oscillation phase and the length of the fixed delay.

The invention also relates to an image display device including:
a matrix of cells arranged in rows and columns, which cells may or may not be activated by a write voltage,
a row driver circuit to sequentially select the rows of cells,
a column driver circuit, having a plurality of switches, to apply via said switches a write signal to the columns of cells to be activated for the selected row,
a resonant circuit to generate said write signal, said write signal having a first part in which it swings from a write voltage to zero voltage, said resonant circuit having an inductive element resonating with the capacitance of the columns of cells being activated for the selected row during said first oscillation part and at least one switch to trigger said oscillation,
a control circuit for controlling said switches of said column driver circuit and said at least one switch of said resonant circuit, which control circuit drives said at least one switch of the resonant circuit according to the capacitance of the columns having cells being activated in the selected row and the switches of the column driver circuit such that they change state at the end of said first oscillation part,
wherein the control circuit determines the start of the first oscillation phase from the duration of a prior oscillation phase, called the second oscillation phase, during which the write signal swings from zero voltage to the write voltage for the same number of cells being activated in the selected row.

The control circuit includes for example:
first means for triggering the switching actions of the switches of the column driver circuit with a fixed delay with respect to the pulses of a clock signal, and
second means for triggering the change of state of said at least one switch of the resonant circuit with a variable delay with respect to the pulses of said clock signal H, which variable delay is a function of the capacitance of the columns having cells being activated in the selected row.

The second means include:
means for measuring the duration of the second oscillation phase, said second oscillation phase having the same duration as said first oscillation phase, and
means for determining the length of the variable delay which corresponds to the difference between the duration of the second oscillation phase and the length of the fixed delay.

According to a particular embodiment, the control circuit includes:
a capacitive element,
a current generator intended to supply current to said capacitive element,
a first detection circuit to detect the direction of the current flowing in the inductive element of the resonant circuit, trigger the switching actions of the switches of the column driver circuit when said current changes direction, changing from a “positive” direction to a “negative” direction, and trigger operation of the current generator when the direction of the current flowing in the inductive element is positive, said capacitive element attaining a first charge value at the end of this first operating period,
a circuit to trigger operation of the current generator during a second operating period such that the voltage across the terminals of said capacitive element attains a threshold value, the duration of said second operating period being equal to the variable delay, and
a second detection circuit to detect the voltage across the terminals of said capacitive element and control the change of state of said at least one switch of the resonant circuit when the voltage across the terminals of said capacitive element reaches said threshold value.

### BRIEF DESCRIPTION OF THE DRAWINGS

The invention will be better understood on reading the description that follows, given by way of non-limiting example and with reference to the accompanying drawings in which:

FIG. 1 represents a two-switch column amplifier connected to the columns of cells in a display panel via a column driver circuit;

FIG. 2 shows the voltage signal produced by the column amplifier of FIG. 1;

FIG. 3 shows the shape of the voltage signal produced by the column amplifier when the capacitance of the columns of switched cells varies;

FIG. 4 shows the various operating phases of the column amplifier to produce the signal of FIG. 2 and the current flowing in the inductive element of the column amplifier during said phases;

FIG. 5, to be compared with FIG. 4, illustrates the principle of the invention;

FIG. 6 represents a device to implement the control method of the invention;

FIG. 7 shows timing diagrams illustrating the states of the various components of the device of FIG. 6 during operation of the device; and

FIG. 8 shows timing diagrams illustrating operation of the device of FIG. 6 for two consecutive column capacitance values.

### DESCRIPTION OF PREFERRED EMBODIMENTS

The invention can be applied to any type of display device having a cell-based display matrix, a row driver circuit to sequentially select the rows of cells of the matrix, a column driver circuit to apply a write signal to the columns of cells to be activated for the selected row, and a column amplifier forming a resonant circuit with the columns of cells to be activated for the selected row.

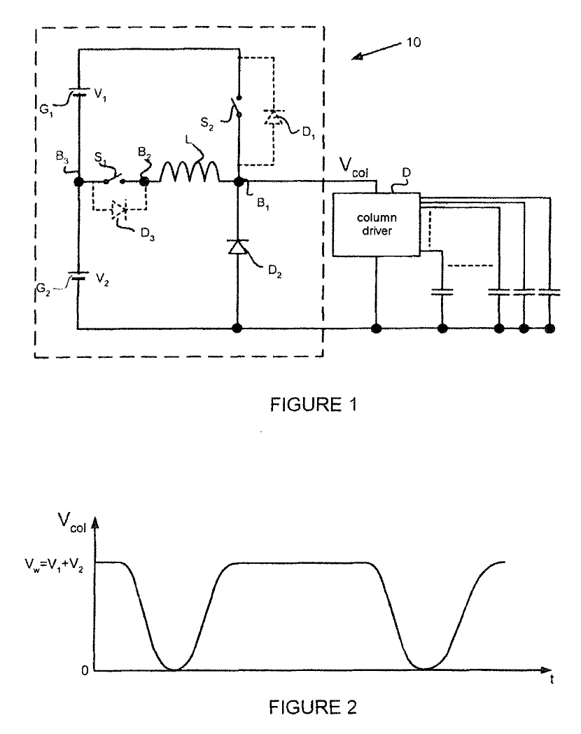

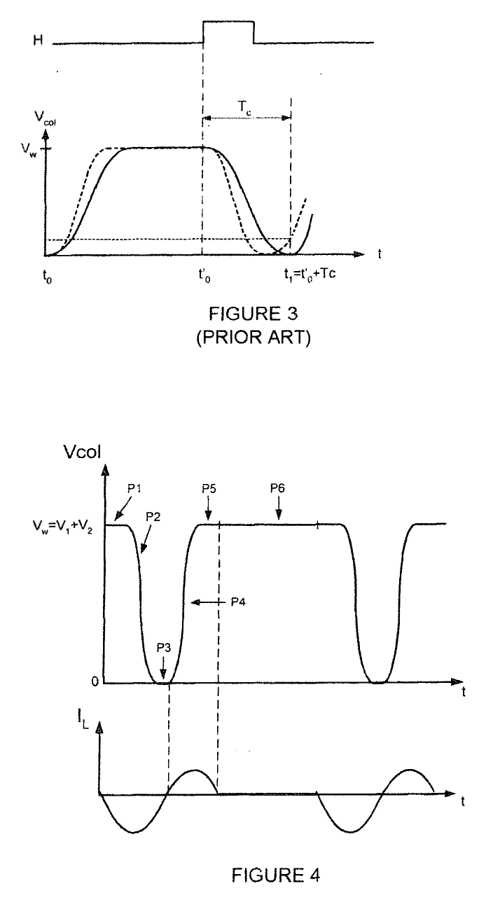

The invention will be described with reference to a column amplifier with two switches as illustrated in FIGS. 1 and 2. Of course, the invention can be applied to other types of column amplifier, in particular that of Weber disclosed in US patent U.S. Pat. No. 4,866,349.

The invention involves controlling the start of oscillations in the column amplifier such that the switching actions of the switches in the column driver circuit always take place when voltage V_{col} is zero.

Before describing the control method of the invention in detail, it is appropriate to describe in detail the operation of the column amplifier of FIG. 1. This amplifier, referenced 10, is connected, via a column driver circuit D, to the columns of cells to be activated on the display panel.

Amplifier 10 has an inductive element L to store magnetic energy and to discharge it in the capacitances of the columns of cells to be activated on the panel. Inductive element L is connected, via a first terminal B₁, to column driver circuit D. The second terminal B₂ of inductive element L is connected, via a switch S₁, to the positive terminal of a voltage source G₂ capable of delivering a DC voltage V₂. The negative terminal of source G₂ is connected to ground. In addition, a diode D₂ is inserted between terminal B₁ of the inductive element and ground, with the cathode connected to terminal B₁ of the inductive element. A voltage source G₁, capable of delivering a DC voltage V₁, is also connected to the terminals of the inductive element via a switch S₂. The negative terminal of source G₁ is connected to terminal B₂ of the inductive element and its positive terminal is connected to switch S₂. A diode D₁ may be placed in parallel with switch S₂, with the cathode connected to the positive terminal of voltage source G₁. In general, this diode corresponds to the diode of the MOS transistor used as switch S₂.

Likewise, a diode D₃ may be placed in parallel with switch S₁, with the cathode connected to the positive terminal of voltage source G₂; this diode corresponds to the diode of the MOS transistor used as switch S₁.

The voltages V₁ and V₂ are defined such that V₁+V₂=V_{w}.

The voltage signal V_{col} at point B₁ of the amplifier and represented in FIG. 2 is arrived at through a sequence of operating phases. These various phases are shown in FIG. 4.

During a first phase, P1, switches S₁ and S₂ are in the closed state. A current I_{L} flows through the circuit formed by voltage source G₁, inductive element L and switches S₁ and S₂. Current I_{L} is positive during this phase. Voltage V₁+V₂=V_{w} is applied across terminals of the display panel columns selected by driver circuit D.

During the next phase, P2, switch S₁ is held in the closed state and switch S₂ is opened. Some of the energy stored in inductive element L is discharged in the columns selected by the column driver circuit until the voltage across the terminals of the columns is zero. Going into more detail, at the start of this phase, inductive element L continues to receive energy, this time no longer from voltage source G₁, but from the column capacitances of the panel. The current therefore continues to increase a little and then decreases. The swing from V_{w} and 0 volts takes place during this phase.

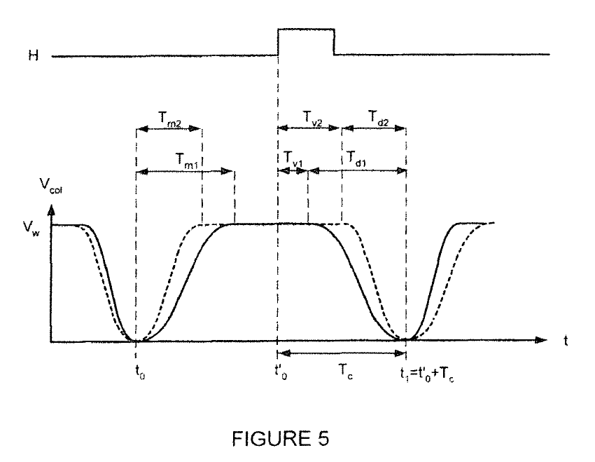

During the next phase, P3, a zero voltage is held across the terminals of the columns of the panel until the current I_{L} through the inductive element becomes zero. During this phase, the states of switches S₁ and S₂ remain unchanged. The remainder of the current stored in inductive element L is absorbed by voltage source G₂ via diode D₂. The duration of this phase is reduced to the minimum possible in order to improve the efficiency of the amplifier. In FIGS. 5, 7 and 8 that follow, this phase will be considered as having an effectively zero-length duration.

During the next phase, P4, the capacitive energy stored in the columns of the cells to be activated on the panel is returned to inductive element L. Current I_{L} then changes direction. The voltage across the terminals of the columns of the panel rises again until the amplitude V_{w}=V₁+V₂ is reached. During this phase, the states of switches S₁ and S₂ remain unchanged from the previous phase. Phases P2 and P4 are of approximately equal duration.

When the voltage across the terminals of the columns of cells to be activated reaches the amplitude V₁+V₂, a write current is produced in said cells to activate them. This is the start of phase P5. Switches S₁ and S₂ may equally be open or closed during this phase. If switch S₁ is open, the write current of the cells flows through the circuit formed by the cell, driver circuit D, inductive element L, diode D₃ and voltage source G₂. Otherwise, the current flows through switch S₁ instead of diode D₃.

At the end of phase P5, switch S₂ is closed and switch S₁ is opened in view of the next phase.

The next phase, P6, is an inactive phase. No current flows. The voltage across the terminals of the panel's columns comprising activated cells is held at V₁+V₂. The aim of this final phase is to improve the efficiency of the device since the conduction losses at this time are zero.

The method of the invention will be described with reference to FIG. 5 in comparison with FIG. 4 which represents the prior art. As in FIG. 4, the solid line curve represents signal V_{col} delivered by the column amplifier for a column capacitance value C₁ between consecutive switching action instants t₀ and t₁. The dotted line curve represents the same signal for a lower column capacitance value C₂.

The switching actions of the switches of the column driver circuit are synchronized on clock signal H as in FIG. 4. They are switched with a delay T_{c} with respect to the pulses of clock signal H. However, the resonance in the resonant circuit is triggered with a variable delay Tᵥ with respect to the same pulses of signal H. This variable delay is defined such that voltage V_{col} is zero at the moment when the switches of the column driver circuit are actioned. In FIG. 5, this variable delay is denoted Tᵥ₁ for the solid line curve and Tᵥ₂ for the dotted line curve.

The value of the variable delay to be applied is a function of the capacitive charge of the switched columns. In fact, this variable delay is obtained by subtracting from T_{c} the time T_{d} that the resonant circuit takes to change from V_{w} to 0. Now, this time T_{d} can be determined beforehand since it is equal to the time Tₘ that the resonant circuit takes to change from 0 to V_{w} for the same capacitive charge. The time Tₘ can be measured just after the previous switching action. In the case of the solid line curve (column capacitance equal to C₁), the time T_{d1} to change from V_{w} to 0 can be determined by measuring the time Tₘ₁. Likewise, for the dotted line curve (column capacitance equal to C₂), the time T_{d2} can be determined by measuring the time Tₘ₂.

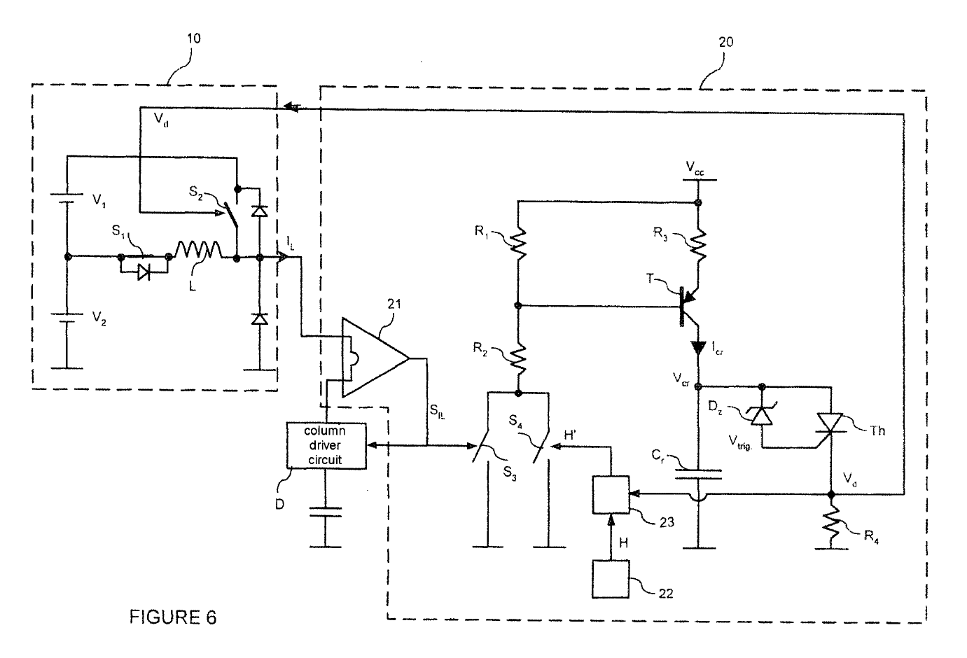

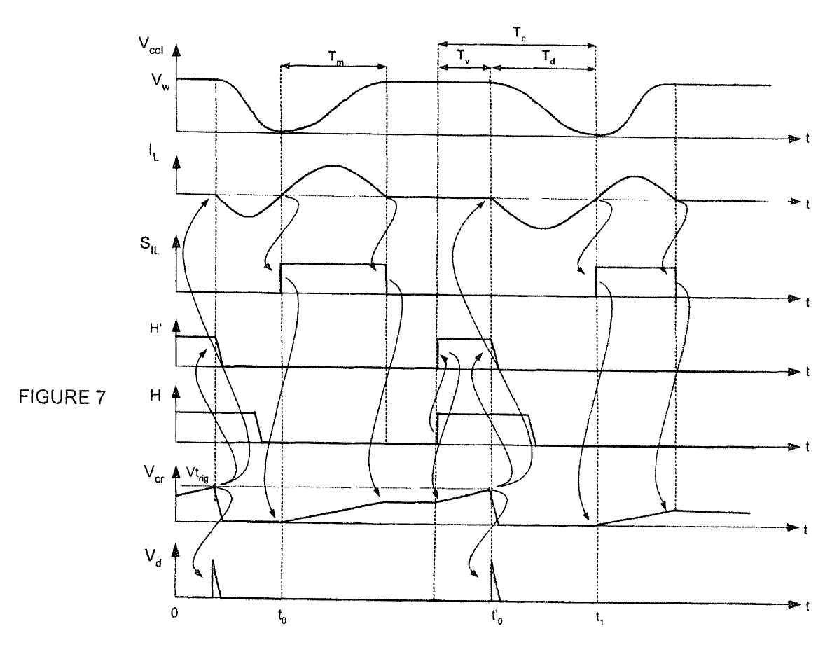

A device 20 implementing the method is proposed with reference to FIG. 6. This device is placed between the output of column amplifier 10 and column driver circuit D.

This device includes a circuit 21 for detecting the direction of current I_{L} flowing in inductive element L of amplifier 10. This circuit delivers an output signal S_{IL} that is non-zero (equal to 1) when current I_{L} flowing from inductive element L to the columns of cells (positive current I_{L} in FIG. 4) is positive and an output signal that is zero when current I_{L} flows in the other direction. This output signal is used by column driver circuit D for triggering the switching actions of its switches. Signal S_{IL} is also used to control a current generator intended to supply a capacitive element Cᵣ.

The current generator is made up of three resistive elements R₁, R₂, R₃, a transistor T and two switches S₃ and S₄. The resistive elements are placed in series between a power supply terminal V_{cc} receiving a power supply voltage and, via switches S₃ and S₄, ground. More specifically, switches S₃ and S₄ are placed in parallel between the terminal of resistor R₂ not connected to resistor R₁ and ground. Switch S₃ is controlled by signal S_{IL} and switch S₄ is controlled by a signal H′. Moreover, the mid-point between resistive elements R₁ and R₂ is connected to the base of bipolar transistor T. Resistive element R₃ is connected between power supply terminal V_{cc} and the emitter of transistor T. Lastly, the collector of transistor T is connected to a terminal of capacitive element Cᵣ. The other terminal of the latter is connected to ground. When either of switches S₃ and S₄ is closed, this generator supplies current to capacitive element Cᵣ. The intensity of current I_{cr} supplied by the current generator is fixed by the resistance of resistive elements R₁, R₂, R₃ and the value of the power supply voltage.

A device made up of a thyristor Th, a zener diode D_{z} and a resistive element R₄ is responsible for delivering a short voltage pulse each time the voltage across the terminals of capacitive element Cᵣ reaches voltage V_{trig}. Voltage V_{trig} is the threshold voltage of diode D₂. The voltage signal, denoted V_{d}, delivered by this circuit is used to control the opening of switch S₂ of the column amplifier. The anode of thyristor Th and the cathode of zener diode D_{z} are connected to the collector of transistor T and the cathode of the thyristor is connected to ground via resistive element R₄. Lastly, the cathode of diode D_{z} is connected to the gate of the thyristor and signal V_{d} corresponds to the signal delivered by the cathode of the thyristor.

Finally, a clock circuit 22 is responsible for delivering clock signal H. This signal is supplied to an SR (Set Reset) flip-flop 23 which also receives signal V_{d}. The flip-flop switches to 1 on the front edge of clock signal H, and falls back to 0 on the pulses of signal V_{d}. The output of flip-flop 23 is control signal H′ for switch S₄.

Referring to the timing diagrams of FIG. 7, the control circuit 20 operates as follows. At instant 0, clock signals H and H′ are at 1. Switch S₄ is therefore closed and capacitive element Cᵣ charges up by the current supplied by transistor T. When voltage V_{cr}, across the terminals of capacitive element Cᵣ, reaches the value V_{trig}, thyristor Th is triggered. A short voltage pulse appears in control signal V_{d}, which pulse triggers the opening of switch S₂ of the column amplifier. Inductive element L of the column amplifier then begins to resonate with the capacitance of the columns selected by driver circuit D. A negative current I_{L} (flowing from the columns of cells to inductive element L) then flows through inductive element L. The pulse on signal V_{d} also triggers a falling edge in signal H′, which in turn causes switch S₄ to open. Capacitive element Cᵣ discharges, through thyristor Th, to ground. When capacitive element Cᵣ is completely discharged, thyristor Th is deactivated.

When current I_{L} becomes zero, circuit 21 detects a change of direction of current I_{L}, and signal S_{IL} changes to 1 which in turn triggers the closure of switch S₃ and the switching actions of the switches of column driver circuit D. Capacitive element Cᵣ starts charging up with the current supplied by transistor T. An oscillation causing voltage V_{col} to change from 0 to V_{w} also starts. When voltage V_{col} reaches voltage V_{w}, current I_{L} becomes zero and circuit 21 then detects a change of direction of the current; signal S_{IL} becomes zero. Switch S₃ opens and the charging of capacitive element Cᵣ is interrupted. The charge of capacitive element Cᵣ is hence representative of the time Tₘ for voltage V_{col} to change from 0 to V_{w} with the present column capacitance. The charge of capacitive element Cᵣ is held at this value until the next rising edge of clock signal H. The element Cᵣ then resumes its charging to reach V_{trig}. When the charge voltage of element Cᵣ reaches V_{trig}, switch S₄ opens and the cycle repeats as described above.

With this device, variable time Tᵥ is defined as the additional time required such that the voltage across the terminals of capacitive element Cᵣ reaches V_{trig} after having previously been charged during the swing 0→V_{w} of signal V_{col}. The value V_{trig} is defined as follows:
V_{Cr}=K.t→V_{trig}=K.(Tᵥ+T_{d})=K.(Tᵥ+Tₘ)
Given that T_{c}=Tᵥ+T_{d}
→V_{trig}=K.T_{c}

In order that device 20 operates correctly, it must be ensured that

$${T}_{c} > \frac{1}{2} π \sqrt{L \cdot {C}_{tot}}$$

where Cₜₒₜ represents the capacitance of all the columns of cells that can be selected by driver circuit D.

Delay T_{c} is independent of the capacitance of the columns selected by driver circuit D, and depends on V_{trig}, the capacitance of element Cᵣ and current I_{cr}, the latter two parameters fixing K. Although these parameters are constant, they may exhibit some drift according to their tolerances. It may therefore be beneficial to provide an additional device to control the oscillation phase of the resonant circuit on the clock signal. This control (not represented in the diagram of FIG. 6) is implemented by comparing the phase of the column voltage with the phase of the clock signal. The phase difference modifies charge current I_{cr}. Furthermore, since

$$Tc = \frac{{C}_{r} \cdot {V}_{trig}}{{I}_{cr}} ,$$

the phase of the column voltage is controlled by the clock signal.

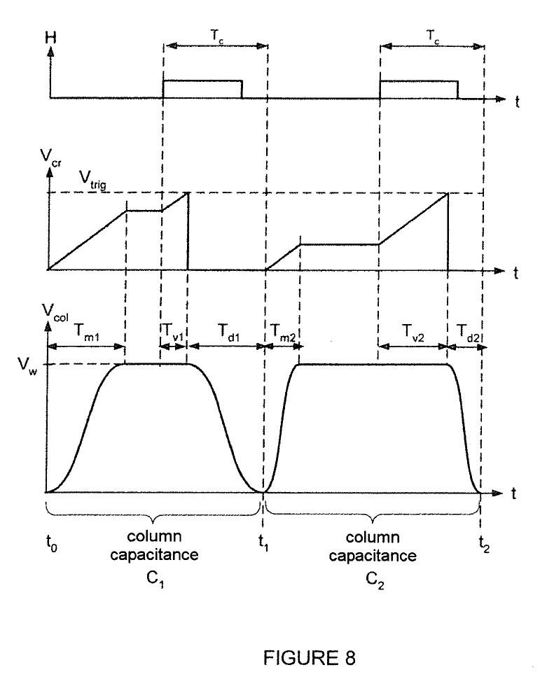

FIG. 8 summarizes the operation of the device of FIG. 6 for two different column capacitance values. The capacitance of the columns selected by driver circuit D is taken to be equal to C₁ between switching action instants t₀ and t₁and equal to C₂ between switching action instants t₁ and t₂, where C₁ is a higher capacitance than C₂. FIG. 8 shows the waveforms of signals V_{col}, V_{cr} and H between switching action instants to and t₂. Times Tₘ₁ and T_{d1} are longer than Tₘ₂ and T_{d2} because C₁ is a higher capacitance than C₂. Conversely, time Tᵥ₂ is longer than time Tᵥ₁ since T_{c}=T_{d1}+Tᵥ₁=T_{d2}+Tᵥ₂. During the rise time of voltage V_{col} the current generator charges capacitive element Cᵣ by supplying current. The charging continues after the rising edge of signal H until voltage V_{cr} reaches voltage V_{trig}. Switch S₂ is then opened and voltage V_{col} then changes from V_{w} to 0.

This dynamic control of switch S₂ of the column amplifier results in a significant improvement in the efficiency of the display panel. Of course, the control method of the invention can be applied to other column amplifier structures. It can very easily be implemented in plasma display panels having a column amplifier.

1. Control method in an image display device including:
a matrix of cells arranged. in rows and columns, which cells may or may not be activated by a write voltage,
a row driver circuit to sequentially select the rows of cells,
a column driver circuit, having a plurality of switches, to apply via said switches a write signal to the columns of cells to be activated for the selected row,
a resonant circuit to generate said write signal, said write signal having a first oscillation phase in which it swings from a write voltage to zero voltage, said resonant circuit having an inductive element resonating during said first oscillation phase with the capacitance of the columns of cells being activated for the selected row,
in which the start of the first oscillation phase is determined as a function of the capacitance of columns of the cells being activated and in which the switches of the column driver circuit are controlled to change state at the end of said first oscillation phase,
wherein the start of the first oscillation phase is determined from the duration of a prior oscillation phase, called the second oscillation phase, during which the write signal swings from zero voltage to the write voltage for the same number of cells being activated in the selected row.

2. Method according to claim 1, wherein the change of state of the switches of the column driver circuit is synchronized on a clock signal.

3. Method according to claim 2, wherein the change of state of the switches of the column driver circuit is offset by a fixed delay with respect to the pulses of the clock signal.

4. Method according to claim 2, wherein the resonant circuit includes at least one switch to trigger the oscillation during said first oscillation phase and in that the change of state of said at least one switch of the resonant circuit is offset by a variable delay with respect to the pulses of the clock signal, which variable delay is a function of the capacitance of the columns having cells being activated in the selected row.

5. Method according to claim 4, wherein the variable delay is calculated by:
measuring the duration of said second oscillation phase, and
deriving the length of the variable delay which corresponds to the time difference between the duration of the second oscillation phase and the length of the fixed delay.

6. Image display device including:
a matrix of cells arranged in rows and columns, which cells may or may not be activated by a write voltage,
a row driver circuit to sequentially select the rows of cells,
a column driver circuit, having a plurality of switches, to apply via said switches a write signal to the columns of cells to be activated for the selected row,
a resonant circuit to generate said write signal, said write signal having a first part in which it swings from a write voltage to zero voltage, said resonant circuit having an inductive element resonating with the capacitance of the columns of cells being activated for the selected row during said first oscillation part and at least one switch to trigger said oscillation,
a control circuit for controlling said switches of said column driver circuit and said at least one switch of said resonant circuit, which control circuit drives said at least one switch of the resonant circuit according to the capacitance of the columns having cells being activated in the selected row and the switches of the column driver circuit such that they change state at the end of said first oscillation part,
wherein the control circuit determines the start of the first oscillation phase from the duration of a prior oscillation phase, called the second oscillation phase, during which the write signal swings from the zero voltage to the write voltage for the same number of cells being activated in the selected row.

7. Device according to claim 6, wherein the control circuit includes:
first means for triggering the switching actions of the switches of the column driver circuit with a fixed delay with respect to the pulses of a clock signal, and
second means for triggering the change of state of said at least one switch of the resonant circuit with a variable delay with respect to the pulses of said clock signal H, which variable delay is a function of the capacitance of the columns having cells being activated in the selected row.

8. Device according to claim 7, wherein the second means include:
means for measuring the duration of said second oscillation phase, said second oscillation phase having the same duration as said first oscillation phase, and
means for determining the length of the variable delay which corresponds to the difference between the duration of the second oscillation phase and the length of the fixed delay.

9. Device according to claims 6, wherein the control circuit includes:
a capacitive element,
a current generator intended to supply current to said capacitive element,
a first detection circuit to detect the direction of the current flowing in the inductive element of the resonant circuit, trigger the switching actions of the switches of the column driver circuit when said current changes direction, changing from a “positive” direction to a “negative” direction, and trigger operation of the current generator when the direction of the current flowing in the inductive element is positive, said capacitive element attaining a first charge value at the end of this first operating period,
a circuit to trigger operation of the current generator during a second operating period such that the voltage across the terminals of said capacitive element attains a threshold value, the duration of said second operating period being equal to the variable delay, and
a second detection circuit to detect the voltage across the terminals of said capacitive element and control the change of state of said at least one switch of the resonant circuit when the voltage across the terminals of said capacitive element reaches said threshold value.
